(19) United States
(12) Patent Application Publication
(10) Pub. No.: US 2023/0082842 A1
(43) Pub. Date: Mar. 16, 2023

(54) METHOD FOR REPAIRING CATHODE MATERIAL OF SPENT LITHIUM-ION BATTERY

(71) Applicant: Kunming University of Science and Technology, Kunming City (CN)

(72) Inventors: Yingjie Zhang, Kunming City (CN); Peng Dong, Kunming City (CN); Qi Meng, Kunming City (CN); Yannan Zhang, Kunming City (CN); Zitong Fei, Kunming City (CN); Chenchen Li, Kunming City (CN); Lei Liu, Kunming City (CN); Jin Yan, Kunming City (CN)

(73) Assignee: Kunming University of Science and Technology, Kunming City (CN)

(21) Appl. No.: 17/664,298

(22) Filed: May 20, 2022

(30) Foreign Application Priority Data
Sep. 15, 2021 (CN) 202111081330.4

(51) Int. Cl. H01M 10/54; H01M 10/0525; H01M 4/525

(52) U.S. Cl. CPC H01M 10/54; H01M 10/0525; H01M 4/525; H01M 2004/028

(57) ABSTRACT

The present disclosure describes a method for repairing a cathode material of a spent lithium-ion battery, which includes: mixing the cathode material of the spent lithium-ion battery, a lithium sheet, a solid oxidant and absolute ethanol under a protective atmosphere for repairing to obtain a repaired cathode material of the lithium-ion battery, where a temperature for the repairing is 20-70° C.; a ratio of the amount of substance of lithium atoms to the total amount of substance of other metal atoms in the cathode material of the spent lithium-ion battery is (0.5-1):1, excluding 1:1.

### CROSS REFERENCE TO RELATED APPLICATION

This application claims priority to Chinese Patent Application No. 202111081330.4, filed Sep. 15, 2021, which is herein incorporated by reference in its entirety.

### TECHNICAL FIELD

The present disclosure relates to the technical field of repairing electrode materials, and in particular to a method for repairing a cathode material of a spent lithium-ion battery.

### BACKGROUND ART

A further development of new energy resources is crucial to the survival and the progress of humankind. Although battery cost has been dropped significantly, it is not consistent with the sustainability of the whole life cycle of a lithium-ion battery. It is an ultimate goal to completely recycle every component in a spent battery. However, since a larger expenditure cost comes from a cathode material of the battery, people focus on the recycling of the cathode material of the lithium-ion battery. Currently, the methods for recycling the cathode material mainly include pyrometallurgy, hydrometallurgy and direct recycling. The pyrometallurgy requires a high temperature smelting process and a multi-step purification and separation process. In recent years, researchers have been continuing to explore the pyrometallurgical recovery of the spent battery. For example, Tang et al. (“Recovery and regeneration of lithium cobalt oxide from spent lithium-ion batteries through a low-temperature ammonium sulfate roasting approach.”) used a method of roasting assisted with molten ammonium sulfate to recycle lithium from a spent lithium-ion battery at 400° C., while keeping the extraction rate of lithium and cobalt over 98%. Although the recycling efficiency has been greatly improved, the difficulty in waste gas treatment is inevitable. The hydrometallurgy requires an acid leaching step and a subsequent complicated precipitation step. For example, Chen et al. (“Separation and recovery of valuable metals from spent lithium ion batteries: Simultaneous recovery of Li and Co in a single step.”) put forward an environment friendly method, in which mild tartaric acid is used as a leaching agent and precipitating agent to recycle waste lithium, and the recycling rates of lithium and cobalt reach 98% and 97%, respectively. Although each of the aforementioned two methods can achieve a high recycling rate, both of them completely destroy material particles, and meanwhile require more subsequent steps before returning back to the market for normal use. With increasing attention to the recycling methods of battery materials, a direct regeneration method is more and more favored by the researchers. In a traditional direct regeneration method, a separated material that has been pretreated is further treated, including the processes of re-lithiation and annealing, so as to repair the composition and structural defects of electrode particles, thereby producing a regenerated cathode material. For example, Gao et al. (“Direct recovery of LiCoO₂ from the recycled lithium-ion batteries via structure restoration.”) used Li₂CO₃ as a lithium source to be directly mixed with a waste cathode powder, and controlled a molar ratio of lithium to cobalt to be 1.00, such that a regenerated LiCoO₂ cathode material could be obtained by calcining at 800° C. Although this method is not limited to simple metal recycling, it still has the problems of a high reaction temperature and strict control of the dosage of lithium.

### SUMMARY

An objective of the present disclosure is to provide a method for repairing a cathode material of a spent lithium-ion battery, which may be carried out at a normal temperature without strictly controlling the dosage of lithium.

In order to realize the aforementioned objective of the present disclosure, the present disclosure provides the following technical solutions.

The present disclosure provides a method for repairing a cathode material of a spent lithium-ion battery, which includes:

mixing the cathode material of the spent lithium-ion battery, a lithium sheet, a solid oxidant and absolute ethanol under a protective atmosphere for repairing to obtain a repaired cathode material of the lithium-ion battery,

wherein a temperature for the repairing is 20-70° C.;

a ratio of the amount of substance of lithium atoms to the total amount of substance of other metal atoms in the cathode material of the spent lithium-ion battery is (0.5-1):1, excluding 1:1.

In some embodiments, a mass ratio of the solid oxidant to the cathode material of the spent lithium-ion battery is (5-10):100.

In some embodiments, the solid oxidant includes one or more of tetramethylpiperidine oxynitride, trichloroisocyanuric acid, N-hydroxyphthalimide, pyridinium chlorochromate and pyridinium dichlorochromate.

In some embodiments, the cathode material of the spent lithium-ion battery includes lithium cobaltate, lithium manganate, a nickel cobalt aluminum ternary cathode material, or a nickel cobalt manganese ternary cathode material.

In some embodiments, a ratio of the mass of the cathode material of the spent lithium-ion battery to the volume of the absolute ethanol is (50-100) g:1 L.

In some embodiments, the lithium sheet has a diameter of 15 mm and a thickness of 1.195-1.205 mm, and a lithium content in the lithium sheet is ≥99.9 wt %;

a ratio of the number of the lithium sheet to the mass of the cathode material of the spent lithium-ion battery is 1:(5-20) g.

In some embodiments, a time for the repairing is 1-5 h.

In some embodiments, the mixing includes: mixing the cathode material of the spent lithium-ion battery, the lithium sheet and the solid oxidant, and then adding the absolute ethanol.

In some embodiments, a method for preparing the cathode material of the spent lithium-ion battery includes:

discharging the spent lithium-ion battery in a sodium chloride solution, and then disassembling to obtain a cathode of the spent lithium-ion battery;

soaking the cathode of the spent lithium-ion battery in an organic solvent, and calcining to obtain the cathode material of the spent lithium-ion battery.

In some embodiments, the organic solvent includes dimethyl sulfoxide or dimethyl carbonate;

a temperature for the calcining is 650-850° C.

The present disclosure provides a method for repairing a cathode material of a spent lithium-ion battery, which includes: mixing the cathode material of the spent lithium-ion battery, a lithium sheet, a solid oxidant and absolute ethanol under a protective atmosphere, and conducting a repairing to obtain a repaired cathode material of the lithium-ion battery, wherein a temperature for the repairing is 20-70° C.; a ratio of the amount of substance of lithium atoms to the total amount of substance of other metal atoms in the cathode material of the spent lithium-ion battery is (0.5-1):1, excluding 1:1. In the present disclosure, the high solubility of ethanol to the lithium sheet and the ability of the solid oxidant to promote the departure of oxygen atoms are utilized. After the cathode material of the spent lithium-ion battery is mixed with the lithium sheet, the solid oxidant and the absolute ethanol, the lithium sheet and the absolute ethanol firstly react to generate lithium ethoxide, and then the processes of lithium removal from lithium ethoxide and lithium intercalation into the cathode material of the spent lithium-ion battery are sequentially realized under the catalytic action of the solid oxidant. Finally, an objective of lithium supplementation can be achieved. Moreover, an impurity phase and adhesive substance on a surface of waste cathode powder can also be effectively removed by using the similar miscibility principle. Therefore, the repairing method of the present disclosure can carry out the repairing and regenerating process at normal temperature, which achieves the aims of being green, pollution-free and recyclable.

### BRIEF DESCRIPTION OF THE DRAWINGS

FIG. 1 is an XRD pattern of spent-LCO and repaired-LCO of Example 1.

FIG. 2 shows a cycle stability curve of half cells with spent-LCO and repaired-LCO of Example 2 as cathodes.

FIG. 3 shows a cycle stability curve with spent-NCM622 and repaired-NCM622 of Example 3 as cathodes.

### DETAILED DESCRIPTION OF THE EMBODIMENTS

The present disclosure provides a method for repairing a cathode material of a spent lithium-ion battery, which includes:

mixing the cathode material of the spent lithium-ion battery, a lithium sheet, a solid oxidant and absolute ethanol under a protective atmosphere for repairing to obtain a repaired cathode material of the lithium-ion battery,

wherein a temperature for the repairing is 20-70° C.;

a ratio of the amount of substance of lithium atoms to the total amount of substance of other metal atoms in the cathode material of the spent lithium-ion battery is (0.5-1):1, excluding 1:1.

In the present disclosure, all raw materials are commercially-available products well known to those skilled in the art, unless otherwise specified.

In the present disclosure, a ratio of the amount of substance of lithium atoms to the total amount of substance of other metal atoms in the cathode material of the spent lithium-ion battery is preferably (0.5-1):1, and more preferably (0.7-1):1, excluding 1:1.

In the present disclosure, the cathode material of the spent lithium-ion battery preferably includes lithium cobaltate, lithium manganate, ferrous lithium phosphate, a nickel cobalt aluminum ternary cathode material or a nickel cobalt manganese ternary cathode material. The present disclosure does not have any special limitation on the specific type of the nickel cobalt aluminum ternary cathode material or the nickel cobalt manganese ternary cathode material, and a type well known to those skilled in the art may be used. In a specific embodiment of the present disclosure, the cathode material of the spent lithium-ion battery is specifically lithium cobaltate and LiNi_{0.6}Co_{0.2}Mn_{0.2}O₂ (NCM622).

In the present disclosure, a method for preparing the cathode material of the spent lithium-ion battery preferably includes:

discharging the spent lithium-ion battery in a sodium chloride solution, and then disassembling to obtain a cathode of the spent lithium-ion battery;

soaking the cathode of the spent lithium-ion battery in an organic solvent, and calcining to obtain the cathode material of the spent lithium-ion battery.

In the present disclosure, the spent lithium-ion battery is discharged in a sodium chloride solution, and then disassembled to obtain a cathode of the spent lithium-ion battery.

In the present disclosure, a mass concentration of the sodium chloride solution is preferably 5-8%, and more preferably 6-7%. The present disclosure does not have any special limitation on the discharge process, and a process well known to those skilled in the art with assurance of complete discharge may be used.

The present disclosure does not have any special limitation on the process of disassembling, and a process well known to those skilled in the art may be used.

In the present disclosure, after the cathode of the spent lithium-ion battery is obtained, the cathode of the spent lithium-ion battery is soaked in an organic solvent, and calcined to obtain the cathode material of the spent lithium-ion battery.

In the present disclosure, the organic solvent preferably includes dimethyl sulfoxide or dimethyl carbonate.

In the present disclosure, the soaking is conducted at a temperature of preferably room temperature for a time of preferably 2-8 h, and more preferably 4-6 h. In the present disclosure, the soaking may effectively remove electrolytes and separate the active cathode material from the current collector, thereby obtaining the active cathode material.

In the present disclosure, the calcining is conducted at a temperature of preferably 650-850° C., and more preferably 680-720° C. for a time of preferably 5-12 h, and more preferably 7-9 h.

In the present disclosure, the calcining serves to remove a binder and a conductive agent from the active cathode material.

In the present disclosure, the lithium sheet is preferably a lithium sheet recycled from a spent lithium-ion battery. Such a choice of the lithium sheet may further realize the resource reuse and reduce the cost.

In the present disclosure, the lithium sheet has a diameter of preferably 15 mm, and a thickness of preferably 1.195-1.205 mm, and more preferably 1.2 mm. The lithium sheet has a purity of preferably ≥99.9%.

In the present disclosure, the solid oxidant preferably includes one or more of tetramethylpiperidine oxynitride (TEMPO), trichloroisocyanuric acid, N-hydroxyphthalimide, pyridinium chlorochromate and pyridinium dichlorochromate, and more preferably TEMPO. When the solid oxidant is two or more of the aforementioned specific selections, the present disclosure does not have any special limitation on the proportion of the aforementioned specific substances, and any proportion may be used for mixing.

In the present disclosure, a mass ratio of the solid oxidant to the cathode material of the spent lithium-ion battery is preferably (5-10):100, and more preferably (6-8:):100.

In the present disclosure, a ratio of the mass of the cathode material of the spent lithium-ion battery to the volume of the absolute ethanol is preferably (50-100) g:1 L, more preferably (60-90) g:1 L, and most preferably (70-80) g:1 L.

In the present disclosure, a ratio of the number of the lithium sheet to the mass of the cathode material of the spent lithium-ion battery is preferably 1:(5-20) g, and more preferably 1:(10-15) g.

In the present disclosure, the mixing preferably includes: mixing the cathode material of the spent lithium-ion battery, the lithium sheet and the solid oxidant, and then adding the absolute ethanol. The present disclosure does not have any special limitation on the addition rate of the absolute ethanol, and an addition rate well known to those skilled in the art with assurance of reacting safely and thoroughly may be used.

In the present disclosure, the protective atmosphere is preferably a nitrogen atmosphere.

In the present disclosure, the repairing is preferably carried out under the condition of stirring. The present disclosure does not have any special limitation on the rotation speed of the stirring, and a rotation speed well known to those skilled in the art may be used.

In the present disclosure, the repairing is conducted at a temperature of 20-70° C., and preferably 45-55° C. for a time of preferably 1-5 h, and more preferably 1-1.5 h.

After the repairing is completed, the present disclosure further preferably includes a post-treatment, which preferably includes suction filtration and drying in sequence. The present disclosure does not have any special limitation on the process of suction filtration, and a process well known to those skilled in the art may be used. In the present disclosure, the drying is preferably vacuum drying; the vacuum drying is conducted at a temperature of preferably 120-200° C., and more preferably 150-160° C. for a time of preferably 5-10 h, and more preferably 6-8 h.

The method for repairing a cathode material of a spent lithium-ion battery as provided by the present disclosure will be described in detail below in connection with the examples, which should not be construed as limiting the claimed scope of the present disclosure.

### EXAMPLE 1

A spent lithium-ion battery with lithium cobaltate as a cathode material was fully discharged in a solution of sodium chloride with a mass concentration of 6%, and then the battery was disassembled to obtain a cathode of the spent lithium-ion battery.

The cathode of the spent lithium-ion battery was soaked in dimethyl sulfoxide for 5 h to remove electrolytes, then separated from a current collector, and calcined at 800° C. for 8 h to obtain a cathode material of the spent lithium-ion battery (designated as a spent-LCO).

Under the conditions of a nitrogen atmosphere and 25° C., 5 g of the spent-LCO, a lithium sheet (with a diameter of 15 mm, a thickness of 1.2 mm and a purity ≥99.9%) and 0.25 g of TEMPO were put in a same container, slowly added with 20 mL of absolute ethanol, then stirred for 1 h, subjected to suction filtration, and dried in vacuum at 200° C. for 8 h to obtain repaired lithium cobaltate (designated as a repaired-LCO).

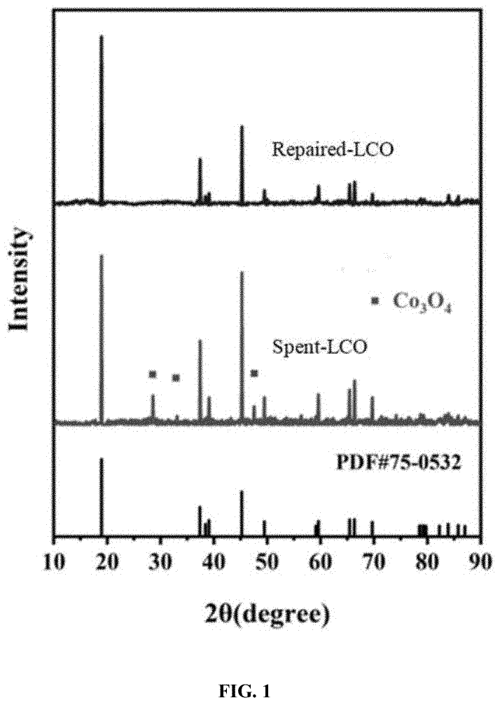

An XRD test was carried out on the spent-LCO and the repaired-LCO, and the test results are shown in FIG. 1. It can be seen from FIG. 1 that the spent-LCO contained trace amount of a cobaltosic oxide impurity, and the repaired-LCO has no other impurity phase, thereby realizing the process of lithium supplementation.

### EXAMPLE 2

A spent lithium-ion battery with lithium cobaltate as a cathode material was fully discharged in a solution of sodium chloride with a mass concentration of 7%, and then the battery was disassembled to obtain a cathode of the spent lithium-ion battery.

The cathode of the spent lithium-ion battery was soaked in dimethyl sulfoxide for 4 h to remove electrolytes, then separated from a current collector, and calcined at 800° C. for 10 h to obtain a cathode material of the spent lithium-ion battery (designated as a spent-LCO).

Under the conditions of a nitrogen atmosphere and 27° C., 15 g of the spent-LCO, a lithium sheet (with a diameter of 15 mm, a thickness of 1.2 mm and a purity ≥99.9%) and 0.75 g of TEMPO were put in a same container, slowly added with 20 mL of absolute ethanol, then stirred for 1.5 h, subjected to suction filtration, and dried in vacuum at 150° C. for 10 h to obtain a repaired lithium cobaltate (designated as a repaired-LCO).

### EXAMPLE 3

A spent lithium-ion battery with NCM622 as a cathode material was fully discharged in a solution of sodium chloride with a mass concentration of 8%, and then the battery was disassembled to obtain a cathode of the spent lithium-ion battery.

The cathode of the spent lithium-ion battery was soaked in dimethyl sulfoxide for 8 h to remove electrolytes, then separated from a current collector, and calcined at 800° C. for 10 h to obtain a cathode material of the spent lithium-ion battery (designated as a spent-NCM622).

Under the conditions of a nitrogen atmosphere and 32° C., 15 g of the spent-NCM622, a lithium sheet (with a diameter of 15 mm, a thickness of 1.2 mm and a purity ≥99.9%) and 0.75 g of TEMPO were put in a same container, slowly added with 20 mL of absolute ethanol, then stirred for 1.5 h, subjected to suction filtration, and dried in vacuum at 180° C. for 8 h to obtain a repaired NCM622 (designated as a repaired-NCM622).

### TEST EXAMPLE

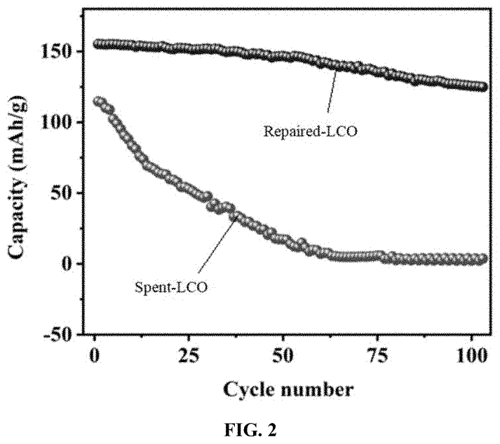

The spent-LCO and the repaired-LCO of Example 2 were used as cathodes respectively, a lithium sheet was used as an anode, LiPF₆/EC/DMC was used as an electrolyte, and PP was used as a diaphragm to form half cells. The assembled half cells were subjected to a constant-current charge and discharge test at a current density of 1C. The test results are shown in FIG. 2. It can be seen from FIG. 2 that the first discharge specific capacity of the repaired lithium cobaltate is 155.384 mAh/g, and the capacity retention rate after 100 cycles is 90.79%, showing good cycle stability.

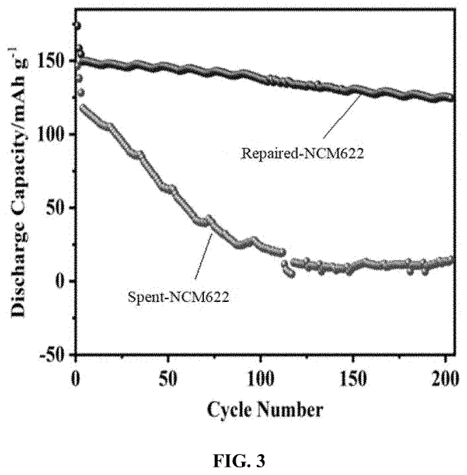

The spent-NCM622 and the repaired-NCM622 of Example 3 were used as cathodes respectively, a lithium sheet was used as an anode, LiPF₆/EC/DMC was used as an electrolyte, and PP was used as a diaphragm to form half cells. The assembled half cells were subjected to a constant-current charge and discharge test at a current density of 1C. The test results are shown in FIG. 3. It can be seen from FIG. 3 that the discharge specific capacity of the repaired NCM622 after three cycles of activation is 149.527 mAh/g, and the capacity retention rate after 200 cycles is 83.3%, showing good cycle stability.

The above description is only preferred embodiments of the present disclosure. It should be pointed out that, for those of ordinary skills in the art, several improvements and modifications can be made without departing from the principle of the present disclosure. These improvements and modifications should also be considered as falling into the claimed scope of the present disclosure.

1. A method for repairing a cathode material of a spent lithium-ion battery, comprising:
mixing the cathode material of the spent lithium-ion battery, a lithium sheet, a solid oxidant and absolute ethanol under a protective atmosphere for repairing to obtain a repaired cathode material of the lithium-ion battery,
wherein a temperature for the repairing is in a range of 20-70° C.; and
a ratio of an amount of substance of lithium atoms to a total amount of substance of other metal atoms in the cathode material of the spent lithium-ion battery is in a range of (0.5-1):1, excluding 1:1.

2. The method according to claim 1, wherein a mass ratio of the solid oxidant to the cathode material of the spent lithium-ion battery is in a range of (5-10):100.

3. The method according to claim 1, wherein the solid oxidant comprises one or more of tetramethylpiperidine oxynitride, trichloroisocyanuric acid, N-hydroxyphthalimide, pyridinium chlorochromate and pyridinium dichlorochromate.

4. The method according to claim 1, wherein the cathode material of the spent lithium-ion battery comprises lithium cobaltate, lithium manganate, a nickel cobalt aluminum ternary cathode material, or a nickel cobalt manganese ternary cathode material.

5. The method according to claim 1, wherein a ratio of a mass of the cathode material of the spent lithium-ion battery to a volume of the absolute ethanol is in a range of (50-100) g:1 L.

6. The method according to claim 1, wherein the lithium sheet has a diameter of 15 mm and a thickness in a range of 1.195-1.205 mm, and a lithium content in the lithium sheet is ≥99.9 wt%; and
a ratio of a number of the lithium sheet to a mass of the cathode material of the spent lithium-ion battery is in a range of 1:(5-20) g.

7. The method according to claim 1, wherein a time for the repairing is in a range of 1-5 h.

8. The method according to claim 1, wherein the mixing comprises: mixing the cathode material of the spent lithium-ion battery, the lithium sheet and the solid oxidant, and then adding the absolute ethanol.

9. The method according to claim 1, wherein a method for preparing the cathode material of the spent lithium-ion battery comprises:
discharging the spent lithium-ion battery in a sodium chloride solution, and then disassembling to obtain a cathode of the spent lithium-ion battery; and
soaking the cathode of the spent lithium-ion battery in an organic solvent, and calcining to obtain the cathode material of the spent lithium-ion battery.

10. The method according to claim 9, wherein the organic solvent comprises dimethyl sulfoxide or dimethyl carbonate; and
a temperature for the calcining is in a range of 650-850° C.

11. The method according to claim 3, wherein a mass ratio of the solid oxidant to the cathode material of the spent lithium-ion battery is in a range of (5-10):100.

12. The method according to claim 4, wherein a mass ratio of the solid oxidant to the cathode material of the spent lithium-ion battery is in a range of (5-10):100.
